(19) United States
(12) Patent Application Publication
(10) Pub. No.: US 2014/0064579 A1
(43) Pub. Date: Mar. 6, 2014

(54) APPARATUS AND METHOD FOR GENERATING THREE-DIMENSIONAL FACE MODEL FOR SKIN ANALYSIS

(71) Applicant: ELECTRONICS AND TELECOMMUNICATIONS RESEARCH INSTITUTE, Daejeon (KR)

(72) Inventors: Song-Woo LEE, Daejeon (KR); Soon-Young Kwon, Yangsan (KR); Ju-Yeon You, Daegu (KR); In-Su Jang, Daegu (KR); Jin-Seo Kim, Daejeon (KR)

(73) Assignee: Electronics and Telecommunications Research Institute, Daejeon (KR)

(21) Appl. No.: 13/789,571

(22) Filed: Mar. 7, 2013

(30) Foreign Application Priority Data
Aug. 29, 2012 (KR) 10-2012-0094619

(51) Int. Cl. G06T 7/00

(52) U.S. Cl. CPC G06T 7/0012
USPC 382/128

(57) ABSTRACT

Disclosed herein are an apparatus and method for generating a 3D face model for skin analysis. The apparatus includes a capturing box and a module box. The capturing box has an open surface, and also has another opening that is formed in a surface opposite the open surface and that allows a face of a person to be photographed to be inserted into an internal space of the capturing box. The module box is combined with the capturing box on the open surface of the capturing box, and acquires facial images by capturing the face of the person to be photographed at various angles under different types of lighting in order to generate a 3D face model for the analysis of the skin of the person.

### CROSS REFERENCE TO RELATED APPLICATION

This application claims the benefit of Korean Patent Application No. 10-2012-0094619, filed on Aug. 29, 2012, which is hereby incorporated by reference in its entirety into this application.

### BACKGROUND OF THE INVENTION

1. Technical Field

The present invention relates generally to an apparatus and method for generating a three-dimensional (3D) face model for skin analysis and, more particularly, to an apparatus and method for generating a 3D face model for skin analysis that generate a 3D face model for skin analysis using a plurality of cameras and different types of lighting, thereby enabling the generation of a realistic 3D face model for skin analysis.

2. Description of the Related Art

A facial imaging device is a device for acquiring images of the skin, and functions to help a doctor treat and diagnose a patient based on the appearance and condition of the patient's skin. The facial imaging device also functions as a skin image analysis system that analyzes desired skin lesions using fluorescence and polarized light.

Conventional facial imaging devices are disadvantageous in that they cannot analyze various skin problems because they can only capture images under a daylight lighting. Accordingly, although general skin imaging apparatuses, such as a video scope, and functional imaging apparatuses, such as fluorescent or polarized light imaging apparatuses, have recently been proposed, the number of types of skin lesions that can be diagnosed is limited because these apparatuses are formed of single-mode hardware, and provides unreproducible results because of the characteristics of contact-measurements.

In particular, conventional fluorescent and polarized light imaging apparatuses are single-mode diagnostic imaging systems so that user may selectively use either fluorescent or polarized light at a time, like an apparatus disclosed in Korean Patent No 10-0853655. Although imaging systems that diagnose color and fluorescent images using white light and ultraviolet rays have recently been commercialized, the case where skin images are acquired using white light does not consider regular reflection on skin surfaces and both the stability and degree of irradiation of light has not been proved with respect to fluorescent images. Furthermore, in order to acquire high-quality images, the uniformity of light radiated onto subjects is essential.

Furthermore, the analysis units of the conventional imaging systems do not consider the differences between the relative skin tones and color values of respective patients. This may cause errors during image analysis because patients have different skin tones and different lesion states. The most critical problems of the conventional imaging systems are the absence of hardware capable of providing composite images and the absence of analysis units capable of quantitatively analyzing skin images.

### SUMMARY OF THE INVENTION

Accordingly, the present invention has been made keeping in mind the above problems occurring in the prior art, and an object of the present invention is to provide an apparatus and method for generating a 3D face model for skin analysis such that the faces of a person are photographed at various angles using a plurality of cameras, thereby enabling the generation of a realistic 3D face model for skin analysis.

Another object of the present invention is to provide an apparatus and method for generating a 3D face model for skin analysis that alternately provide different types of lighting while the face of a person to be photographed, thereby enabling the generation of skin texture for each type of lighting.

In order to accomplish the above objects, the present invention provides an apparatus for generating a 3D face model for skin analysis, including a capturing box configured to have an open surface, and to have another opening surface that is located in opposite the open surface and that allows a face of a person to be photographed to be inserted into an internal space of the capturing box; and a module box combined with the capturing box on the open surface of the capturing box, and configured to acquire facial images by capturing the face of the person to be photographed at various angles and different types of lighting in order to generate a 3D face model for the analysis of the skin of the person to be photographed.

The apparatus may further include a 3D face model generation unit configured to generate the 3D face model.

The 3D face model generation unit may include a skin image extraction unit configured to extract a skin image from the facial image, the skin image including only a skin region; a disparity map generation unit configured to convert the skin image to a disparity map; a triangular mesh formation unit configured to generate 3D coordinates via the disparity map and to form the 3D coordinates into triangular meshes; a skin texture generation unit configured to generate skin texture using the triangular meshes; and a skin texture mapping unit configured to generate the 3D face model by mapping the skin texture to a 3D model.

The module box may include a camera unit including a plurality of cameras configured to photograph the face of the person at various angles; and lighting units including a plurality of light sources configured to radiate white light, polarized light, or ultraviolet (UV) light in order to provide the different types of lighting.

The module box may further includes a control unit configured to control ON/OFF and light intensity of the lighting for each type of light source in order to selectively provide the different types of lighting while the face of the person is being photographed.

The skin texture generation unit may generate white light texture, polarized light texture and UV light texture of the facial images for respective types of lighting.

The apparatus may further include an analysis unit configured to visualize the 3D face model and to analyze the skin of the person been photographed.

The apparatus may further include a feedback device configured to check the alignment of the face of the person to be photographed outside the module box.

In order to accomplish the above objects, the present invention provides a method of generating a 3D face model for skin analysis, including acquiring facial images by capturing a face of a person to be photographed at various angles under different types of lighting; and generating a 3D face model for the analysis of a skin of the person.

Generating the 3D face model may include extracting a skin image from the facial image by separating a skin region; producing a disparity map from the skin images; generating 3D coordinates via the disparity map, and forming the 3D coordinates into triangular meshes; generating skin texture using the triangular meshes; and generating the 3D face model by mapping the skin texture to a 3D model.

Acquiring the facial images may be configured such that the different types of lighting are provided by a plurality of light sources including white light, polarized light and UV light, respectively, and the face of the person to be photographed at various angles by a plurality of cameras.

Acquiring the facial images may be configured to control ON/OFF and light intensity of the lighting for each type of light source in order to selectively provide the different types of lighting while the face of the person t is being photographed.

Generating the skin texture may be configured to generate white light texture, polarized light texture and UV light texture of the facial images for respective types of lighting.

The method may further include, analyzing the skin of the person been photographed by visualizing the 3D face model.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the external configuration of an apparatus for generating a 3D face model for skin analysis according to an embodiment of the present invention;

FIG. 2 is a diagram illustrating the detailed configuration of a module box that is employed in the apparatus for generating a 3D face model for skin analysis according to the embodiment of the present invention;

FIG. 3 is a diagram illustrating the configuration of an apparatus for generating a 3D face model for skin analysis according to an embodiment of the present invention;

FIG. 4 is a diagram illustrating the detailed configuration of a 3D face model generation unit that is employed in the apparatus for generating a 3D face model for skin analysis according to the embodiment of the present invention;

FIG. 5 is a flowchart illustrating a method of generating a 3D face model for skin analysis according to an embodiment of the present invention; and

FIG. 6 is a flowchart illustrating the method of generating a 3D face model for skin analysis according to the embodiment of the present invention in greater detail.

### DESCRIPTION OF THE PREFERRED EMBODIMENTS

The present invention will be described in detail below with reference to the accompanying drawings. Repeated descriptions and descriptions of known functions and constructions which have been deemed to make the gist of the present invention unnecessarily vague will be omitted below. The embodiments of the present invention are provided in order to fully describe the present invention to a person having ordinary knowledge in the art. Accordingly, the shapes, sizes, etc. of elements in the drawings may be exaggerated to make the description clear.

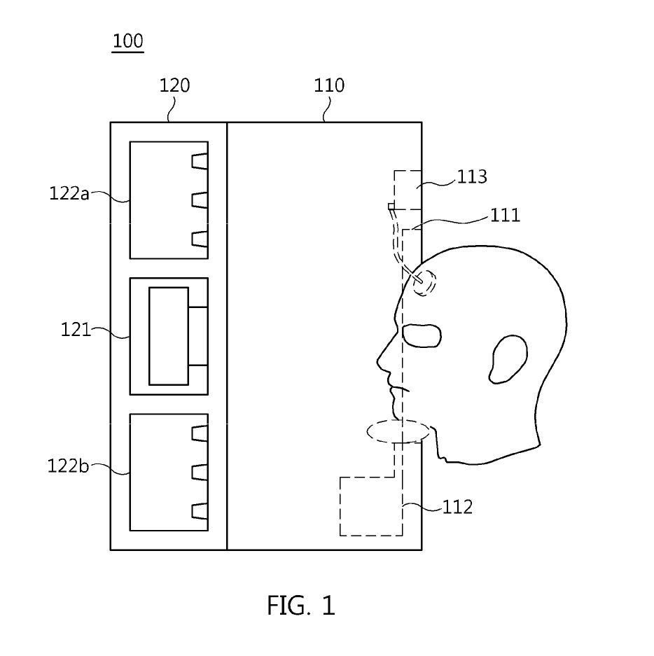

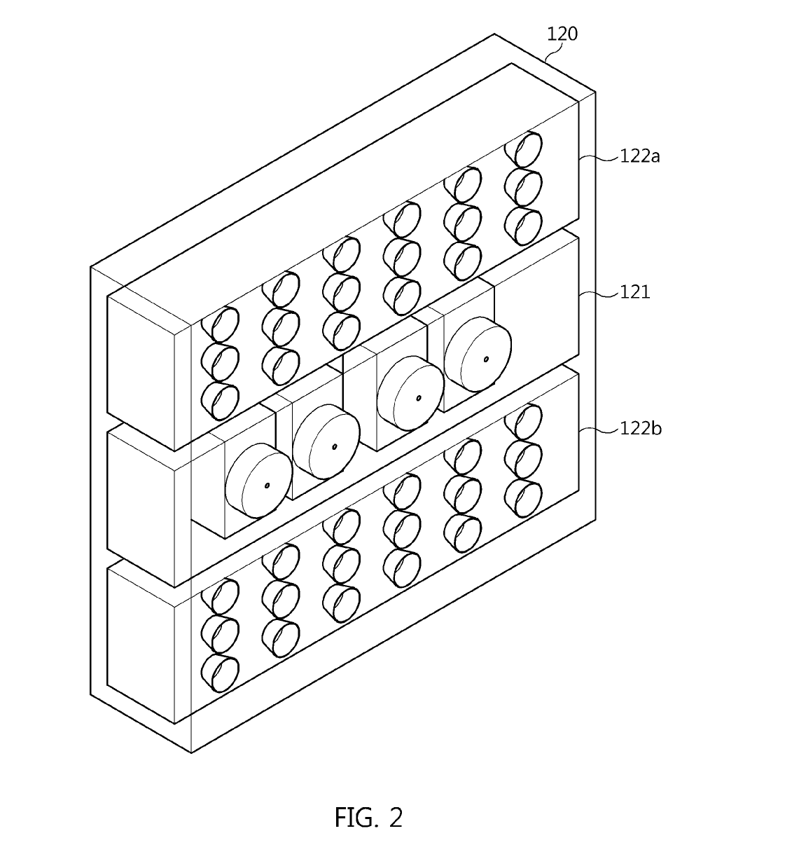

FIG. 1 is a diagram illustrating the external configuration of an apparatus for generating a 3D face model for skin analysis according to an embodiment of the present invention, and FIG. 2 is a diagram illustrating the detailed configuration of a module box that is employed in the apparatus for generating a 3D face model for skin analysis according to the embodiment of the present invention.

As illustrated in FIG. 1, the apparatus 100 for generating a 3D face model for skin analysis according to the embodiment of the present invention includes a capturing box 110 and a module box 120. The module box 120 includes a camera unit 121 and lighting units 122a and 122b.

The capturing box 110 may have an open surface, and have another surface 111 opposite the open surface that allows the face of the person to be inserted into the internal space of the capturing box 110. Furthermore, the capturing box 110 may be provided therein with a chin support 112 for preventing the chin of a person to be photographed to move, and a forehead rest 113 for allowing the forehead of the person to be rested thereon. Furthermore, a dark paint or a cloth is applied to one of the inner surfaces of the capturing box 110, in which the face of the person to be photographed is inserted, so that the color of the face of the person to be photographed and a background can be distinguished from each other. Moreover, to prevent light emitted by the module box 120 from shining directly into the face of the person to be photographed, paint, cloths or diffuser plates may be applied to the remaining surfaces.

The module box 120 is combined with the capturing box 110 on the open surface of the capturing box 110. The module box 120 may acquire facial images by capturing the face of the person to be photographed at various angles under different types of lighting in order to generate a 3D face model to be used for the skin analysis of the person.

For this purpose, the module box 120 may include the camera unit 121 for capturing the face of the person to be photographed and the lighting units 122a and 122b for providing lighting while the face of the person is being photographed.

The camera unit 121 may include a plurality of cameras in order to photograph the face of the person at a variety of angles. The lighting units 122a and 122b may include a plurality of types of light sources 141 in order to provide a plurality of types of lighting when the face of the person is being photographed. The different types of light sources 141 may be classified into a light-emitting diode (LED) light source for radiating white light, an LED light source for radiating polarized light, and an LED light source for radiating ultraviolet (UV) light. Here, a partition is disposed around the polarized LED light source to separate the polarized LED light source from other light sources, and the polarized light LED light source forms polarized light lighting using a polarized light film. The UV LED light source may be preferably formed of an LED device capable of emitting light of 365 mm wavelength in order to emit strong light because the amount of UV light that can be detected by a digital camera is small. Meanwhile, a diffuser plate (not shown) may be provided in front of the lighting units 122a and 122b. The diffuser plate functions to prevent the specular reflection from a specific portion of the face of the person to be photographed by diffusing the light uniformly.

The camera unit 121 and the lighting units 122a and 122b may be arranged in the order of the lighting unit 122a, the camera unit 121 and the lighting unit 122b, as shown in FIG. 2. In greater detail, the camera unit 121 is symmetrically installed with respect to the center of the face to be photographed. In this case, a feedback device for checking the alignment of the face of the person to be photographed externally, that is, a small-sized imaging device (not shown), such as a webcam, may be further installed. Furthermore, apart from this, a mirror may be installed in front of the person so that the person to be photographed can accurately check his or her position. The lighting units 122a and 122b may be arranged above and below the camera unit 121, respectively. The arrangement of the camera unit 121 and the lighting units 122a and 122b may vary depending on whether there is an auxiliary device.

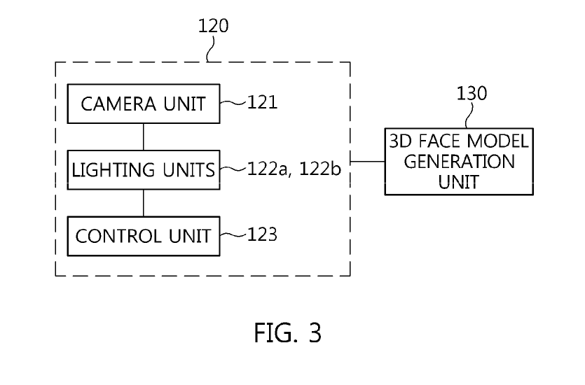

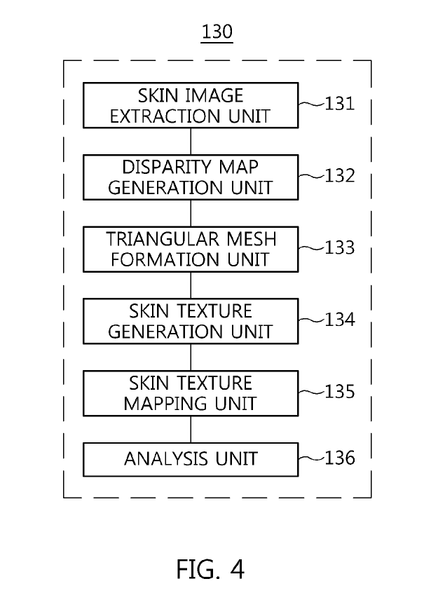

FIG. 3 is a diagram illustrating the configuration of an apparatus 100 for generating a 3D face model for skin analysis according to an embodiment of the present invention, and FIG. 4 is a diagram illustrating the detailed configuration of a 3D face model generation unit that is employed in the apparatus for generating a 3D face model for skin analysis according to the embodiment of the present invention.

As illustrated in FIG. 3, the apparatus 100 for generating a 3D face model for skin analysis according to the embodiment of the present invention includes a camera unit 121, lighting units 122a and 122b, a control unit 123, and a 3D face model generation unit 130.

The camera unit 121 includes a plurality of cameras, and photographs the face of a person at various angles.

The lighting units 122a and 122b include a plurality of LED light sources for radiating white light, polarized light or UV light, and provide different types of lighting.

The control unit 123 controls the ON/OFF and intensity of lighting for each of the light sources in order to selectively provide different types of lighting while the face of the person is being photographed. That is, the control unit 123 alternately provides white-light lighting, polarized-light lighting, and UV-light lighting while the face of the person is being photographed by confirming the administrator of the apparatus for generating a 3D face model 100 the location of the face of the person to be photographed using an image input from the feedback device. Based on this, a facial image captured under the white-light lighting is used to analyze the basic skin, a facial image captured under the polarized-light lighting is used to analyze wrinkles, scars, and the distribution of melanin across the outer layer of the skin, and a facial image captured under the UV-light lighting is used to analyze the state of pores, leukoplakia, the degree of hydration of the skin, the excessiveness of pigment, and cornification. Here, the control unit 123 comprised of a knob configured in the form of a separate ON/OFF switch controls and adjusts the intensity of light in accordance with a capturing environment for each type of light source. For this purpose, the control unit 123 is configured such that circuits designed to control ON/OFF and light intensity are attached to the lighting units 122a and 122b and the knob configured to control ON/OFF and light intensity for each type of light source is installed outside the apparatus 100 for generating a 3D face model, thereby enabling the administrator of the apparatus 100 for generating a 3D face model to easily utilize the control unit 123.

The 3D face model generation unit 130 generates a 3D face model from facial images. For this purpose, the 3D face model generation unit 130 includes a skin image extraction unit 131, a disparity map generation unit 132, a triangular mesh formation unit 133, a skin texture generation unit 134, a skin texture mapping unit 135, and an analysis unit 136, as illustrated in FIG. 4.

The skin image extraction unit 131 extracts a skin image from a facial image, in which case the skin image includes only a skin region. Here, the skin image extraction unit 131 generates the skin image by separating only a skin region from the facial image that is captured under white-light lighting.

The disparity map generation unit 132 produces the facial images as a disparity map using a pixel matching technique. Disparity refers to the degree of difference between the locations of images that are formed by two cameras and that vary depending on the depth information of an object to be captured. A disparity map is acquired by representing the lengths of disparity using numerical values. Here, to improve the accuracy of a disparity map, the disparity map may be corrected by adding a device (not shown) capable of capturing IR images, such as Kinect, and comparing 3D depth information about the feature points of the face extracted from the IR images with the feature points of the face extracted from the disparity map.

The triangular mesh formation unit 133 generates the 3D coordinates of facial feature points via the disparity map, and forms the 3D coordinates into triangular meshes. The triangular mesh formation unit 133 forms triangular meshes capable of optimally representing the depth and shape information of the face of the person having been captured based on the depth information and the facial feature points from the disparity map.

The skin texture generation unit 134 generates skin texture using the triangular meshes. The skin texture generation unit 250 may generate texture for each type of light source, that is, white light texture, polarized light texture, and UV light texture, based on the locations of the vertices of the triangular meshes.

The skin texture mapping unit 135 generates a 3D face model by mapping the skin texture to a 3D model. That is, the skin texture mapping unit 135 maps the white light texture, the polarized light texture, and the UV light texture to the 3D model.

The analysis unit 136 visualizes the 3D face model and then analyzes the skin of the person having been captured.

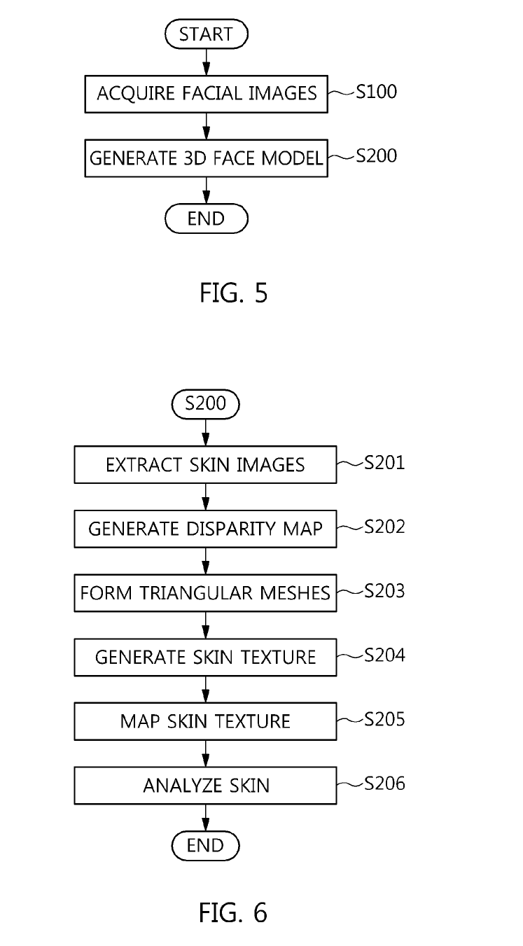

FIG. 5 is a flowchart illustrating a method of generating a 3D face model for skin analysis according to an embodiment of the present invention, and FIG. 6 is a flowchart illustrating the method of generating a 3D face model for skin analysis according to the embodiment of the present invention in greater detail.

As illustrated in FIG. 5, the method of generating a 3D face model for skin analysis according to the embodiment of the present invention is a method that generates a 3D face model for skin analysis from facial images of a person to be photographed using the above-described apparatus 100 for generating a 3D face model. In the following description, redundant descriptions will be omitted.

First, facial images are acquired by capturing the face of the person to be photographed at various angles under different types of lighting at step S100. Here, facial images based on the lighting provided by the white light source, the polarized light source and the UV light source are acquired by controlling the ON/OFF and light intensity of lighting for each type of light source.

Thereafter, a 3D face model for the analysis of the skin of the person having been photographed is generated from the facial images at step S200.

Step S200 is performed in the following sequence.

First, skin images are extracted from the facial images, in which case the skin images include only skin regions at step S201

Thereafter, a disparity map is generated based on the skin images at step S202. Here, the disparity map is acquired using a pixel matching technique.

Thereafter, 3D coordinates are generated via the disparity map, and are formed into triangular meshes at step S203. At step S203, the triangular meshes capable of optimally representing the depth and shape information of the face of the person having been photographed may be formed based on the depth information and the facial feature points on the disparity map generated at step S202.

Thereafter, skin texture is generated using triangular meshes at step S204. At step S204, textures for each type of light source, that is, white light texture, polarized light texture, and UV light texture, may be generated based on the locations of the vertices of the triangular meshes formed at S203.

Thereafter, a 3D face model is generated by mapping the skin texture to a 3D model at step S205. At step S205, the white light texture, the polarized light texture, and the UV light texture generated at step S204 are mapped to the 3D model.

Finally, the 3D face model is visualized and then the skin of the person having been photographed is analyzed at step S206.

The apparatus and method for generating a 3D face model for skin analysis in accordance with the embodiment of the present invention is advantageous in that they photograph the face of a person at various angles using a plurality of cameras, thereby enabling a 3D realistic face model for skin analysis to be generated.

The apparatus and method for generating a 3D face model for skin analysis in accordance with the embodiment of the present invention is advantageous in that that they alternately provide different types of lighting based on different types of light sources when the face of a person to be photographed, thereby enabling skin texture generation based on the characteristics of white light, polarized light and UV light each type of lighting and also enabling the skin of the person to be photographed to be more accurately analyzed in greater detail.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for generating a three-dimensional (3D) face model for skin analysis, comprising:
a capturing box configured to have an open surface, and to have another opening that is formed in a surface opposite the open surface and that allows a face of a person to be photographed to be inserted into an internal space of the capturing box; and
a module box combined with the capturing box on the open surface of the capturing box, and configured to acquire facial images by capturing the face of the person to be photographed at various angles under different types of lighting in order to generate a 3D face model for the analysis of a skin.

2. The apparatus of claim 1, further comprising a 3D face model generation unit configured to generate the 3D face model.

3. The apparatus of claim 2, wherein the 3D face model generation unit comprises:
a skin image extraction unit configured to extract a skin image from the facial image, the skin image including only a skin region;
a disparity map generation unit configured to convert the skin image to a disparity map;
a triangular mesh formation unit configured to generate 3D coordinates via the disparity map and to form the 3D coordinates into triangular meshes;
a skin texture generation unit configured to generate skin texture using the triangular meshes; and
a skin texture mapping unit configured to generate the 3D face model by mapping the skin texture to a 3D model.

4. The apparatus of claim 3, wherein the module box comprises:
a camera unit including a plurality of cameras configured to photograph the face of the person at various angles; and
lighting units including a plurality of light sources configured to radiate white light, polarized light, and/or ultraviolet (UV) light in order to provide the different types of lighting.

5. The apparatus of claim 4, wherein the module box further comprises a control unit configured to control ON/OFF and light intensity of the lighting for each type of light source in order to selectively provide the different types of lighting while the face of the person is being photographed.

6. The apparatus of claim 5, wherein the skin texture generation unit generates white light texture, polarized light texture and UV light texture of the facial images for respective types of lighting.

7. The apparatus of claim 3, further comprising an analysis unit configured to visualize the 3D face model and to then analyze the skin of the person having been photographed.

8. The apparatus of claim 1, further comprising a feedback device configured to check the alignment of the face of the person to be photographed externally.

9. A method of generating a 3D face model for skin analysis, comprising:
acquiring facial images by capturing a face of a person at various angles under different types of lighting; and
generating a 3D face model for the analysis of a skin of the person having been photographed.

10. The method of claim 9, wherein generating the 3D face model comprises:
extracting a skin image from the facial image, the skin image including only a skin region;
converting the skin images to a disparity map;
generating 3D coordinates via the disparity map, and forming the 3D coordinates into triangular meshes;
generating skin texture using the triangular meshes; and
generating the 3D face model by mapping the skin texture to a 3D model.

11. The method of claim 10, wherein acquiring the facial images is configured such that the different types of lighting are provided by a plurality of light sources configured to radiate white light, polarized light and UV light, respectively, and the face of the person is photographed at various angles by a plurality of cameras.

12. The method of claim 11, wherein acquiring the facial images is configured to control ON/OFF and light intensity of the lighting for each type of light source in order to selectively provide the different types of lighting while the face of the person is being photographed.

13. The method of claim 12, wherein generating the skin texture is configured to generate white light texture, polarized light texture and UV light texture of the facial images for the respective types of lighting.

14. The method of claim 10, further comprising, after generating the 3D face model:
visualizing the 3D face model and then analyzing the skin of the person having been photographed.
